(19) United States
(12) Patent Application Publication
(10) Pub. No.: US 2008/0299409 A1
(43) Pub. Date: Dec. 4, 2008

(54) COMPOSITE METAL ARTICLE

(76) Inventor: Jiahui HU, Xiamen (CN)

Correspondence Address: MATTHIAS SCHOLL, 14781 MEMORIAL DRIVE, SUITE 1319, HOUSTON, TX, 77079, US

(21) Appl. No.: 12/129,774

(22) Filed: May 30, 2008

(30) Foreign Application Priority Data
May 31, 2007 (CN) 200720007249.0
Sep. 21, 2007 (CN) 200720008322.6

(51) Int. Cl. B32B 15/00; B32B 3/00; E04H 17/14; A47B 83/02

(52) U.S. Cl. 428/601; 428/615; 256/59; 108/50.11

(57) ABSTRACT

A composite metal article provided in the present invention includes a carbon steel core and a dissimilar composite metal out-layer, said out-layer combined with the carbon steel core by high pressure forging. As the high pressure forging belongs to the precise forging type, which molded by the method of inpour the metal liquid into the cavity on high pressure, thus it can form a thin composite out-layer out of the carbon steel core; it can combined a composite out-layer with the complex structure carbon steel core thus form a complex structure railing and metal table/chair etc.; it can combined complex structure composite out-layer with the simplex structure carbon steel core thus form a complex structure railings and metal table/chair etc.; as there are no air holes on the composite out-layer surface, it has a precise and nice-looking surface and can manufacture products by a simple post-processing.

### CROSS-REFERENCE TO RELATED APPLICATIONS

This application claims priority benefits to Chinese Patent Application No. 200720007249.0 filed on May 31, 2007 and No. 200720008322.6 filed on Sep. 21, 2007. The contents of all of the aforementioned specifications are incorporated herein by reference.

### BACKGROUND OF THE INVENTION

1. Field of the Invention

This invention relates to metal articles of furniture and railings, and more particularly to a composite metal article.

2. Description of the Related Art

The most existing metal furniture and railings that used in gardening, e.g. indoor/outdoor handrail, banisters, guardrail of green belts or guarding windows, are made of carbon steel, stainless steel or stainless steel clad pipe. The guardrail of furniture made of carbon steel needed anticorrosive treatment to the carbon steel surface, these treatments usually include paint spraying, plastic spraying, zinc spraying, aluminium spaying, aluminium-magnesium alloy spraying or zinc-aluminium alloy spraying etc. These methods exist some disadvantages as following: firstly, it's easy rusty to occur rusty stains; secondly it doesn't benefit to the environmental protection; thirdly, the structures of products are too simple in effect, and can't endure a longtime-anticorrosion. The railings made of stainless steel are rarely rusty, but there still existing the following disadvantages: firstly, they cost much; secondly, there are too many noble metal to be used; thirdly, their structures are too simple. The manufacture process of railings made by stainless steel clad pipe is just covering a stainless steel cover to the carbon steel by mechanism, which solved the expensive and easy rusty problem, but there still existing the following disadvantages: firstly, because it's just covering a stainless steel cover to the carbon steel by mechanism, it can't create complex structure like carvings and figures; secondly, it increase the difficulty of manufacture and reduce the efficiency.

### SUMMARY OF THE INVENTION

The present invention provides a composite metal article that solve the above-mentioned problems brought by the using of the carbon steel, stainless steel or stainless steel clad pipe in making railings.

The present invention provides the following method: a composite metal article which include a carbon steel core and a dissimilar composite metal out-layer, said out-layer combined with the outer surface of the carbon steel core by high pressure forging.

The term “composite out-layer”, as used herein, refer to be a copper, aluminium or zinc composite out-layer.

The term “composite out-layer”, as used herein, refer to be a zinc-aluminium or aluminium-magnesium alloy composite out-layer.

The said composite out-layer has a thickness of 1.0-5.0 mm.

The term “carbon steel core”, as used herein, refer to a hollow carbon steel core.

The term “carbon steel core”, as used herein, refer to a solid carbon steel core.

The term “composite metal articles”, as used herein, have carvings.

The present invention provides a composite metal railing, includes a carbon steel core and a dissimilar composite metal out-layer, the composite out-layer combined with the surface of the carbon steel core by high pressure forging.

The present invention provides a composite metal table/chair, includes a board unit and a leg unit, at least one unit is composite unit, the composite unit includes a carbon steel core and a dissimilar composite metal out-layer which combined with the surface of the carbon steel core by high pressure forging.

The composite metal article disclosed in the present invention, as the composite metal out-layer is combined with the surface of the carbon steel core by high pressure forging, has the advantages as following: firstly, as the high pressure forging belongs to the precise forging type, which molded by the method of inpouring the metal liquid to the cavity on high pressure, so it can form a thin composite out-layer out the carbon steel core; it can combined composite out-layer with the complex structure carbon steel core thus form a complex structure railing or metal table/chair; it can combined complex structure composite out-layer with the simplex structure carbon steel core thus form a complex structure railings and metal table/chair; secondly, as there are no air holes on the composite out-layer surface, it has a precise and nice-looking surface and can manufacture products by a simple post-processing; thirdly, it could have a quick processing speed, and high production efficiency; fourthly the total cost is low; fifthly, it is rustless and stainless; sixthly, it benefits to environmental protection; seventhly, it can maintain anticorrosion for a long time. The materials of the composite outer-layer are copper, aluminium, zinc, as they have low melting points and easy to forging, they can form thin composite out-layer and complex-structure articles. The thickness of the composite out-layer is 1.0-5.0 mm. The out-layer is thin, thus reduce the quantity of used metals and the cost is low. The Carbon steel core is hollow, which reduce the quantity of used carbon steel, lighten the articles. The composite articles are nice-looking for there are carvings on them.

### BRIEF DESCRIPTION OF THE DRAWINGS

Detailed description of the present invention are disclosed in connection with the following figures:

FIG. 1 is a front view for illustrating the composite railings according to embodiment 1

FIG. 2 is a sectional view for illustrating the composite railings according to embodiment 1

FIG. 3 is a sectional view for illustrating the composite railings according to embodiment 2

FIG. 4 is a sectional view for illustrating the composite railings according to embodiment 3

FIG. 5 is a perspective view illustrating the gardening table according to embodiment 4

FIG. 6 is a sectional view for illustrating the gardening table according to embodiment 5

FIG. 7 is a sectional view for illustrating the gardening chair according to embodiment 6

### DETAILED DESCRIPTION OF THE EMBODIMENTS

### Embodiment 1

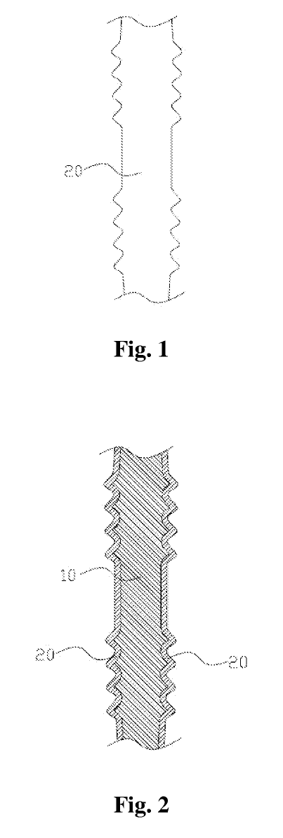

A composite metal railing, as shown in FIG. 1 and FIG. 2, FIG. 1 is a front view for illustrating the composite railings according to the embodiment 1. FIG. 2 is a sectional view for illustrating the composite railings according to embodiment 1, includes a carbon steel core 10 and an aluminium composite out-layer 20. In this embodiment, the material of the composite out-layer 20 is aluminium, without limitation, The other materials e.g. zinc, copper, zinc-aluminium alloy or magnesium-aluminium alloy are also suitable to the embodiment.

The carbon steel core 10 is a solid core with the needed complex shape, combined with the composite out-layer 20 by high pressure forging. The thickness of composite out-layer 20 is 2 mm, and its outer shape is complex carving structure, so the products of composite railings form the complex carving structure. The shape of this embodiment is carving, without limitation, the other structures e.g. figures, animals are also makeable.

Detailed description of the manufacture process of railings in the invention:

P100, step of the manufacture process of core 10, in which the needed shape of the carbon steel core are produced by hot rolling or cold rolling.

P200, step of beginning, in which the needed working mould are put on the working machine, the mould is special steel mould and its inside cavity has the needed shape of railing.

P300, step of setting, in which the carbon steel core 10 are put into the working mould.

P400, step of high pressure forging, in which the melted aluminium liquid is inpoured to the working mould on high pressure, which will fuse to the carbon steel core 10

P500, step of opening, in which the products are take out from the mould, being the railings with needed shape. There can also take some simple process, e.g. spraying to them or grinding to the corners and flanges when needed.

### Embodiment 2

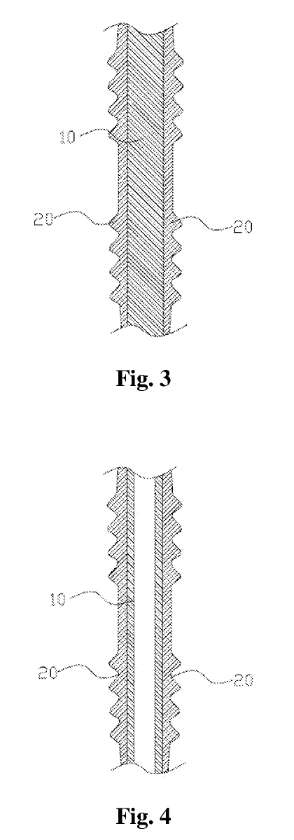

A composite metal railing, as shown in FIG. 3, which is a sectional view for illustrating the composite railings according to embodiment 2, includes a carbon steel core 10 and a aluminium composite out-layer 20. In this embodiment, the material of the composite out-layer 20 is aluminium, without limitation, The other materials e.g. zinc, copper, zinc-aluminium alloy or magnesium-aluminium alloy are also suitable to the embodiment.

The carbon steel core 10 is a solid line stick, with regular rectangle on cross section, combined with the composite out-layer 20 by high pressure forging. The outer shape of the composite out-layer 20 is complex carving, thus the railing product form a complex carving structure. The shape of this embodiment is carving, without limitation, the other structures e.g. figures, animals are also makeable.

### Embodiment 3

A composite metal railing, as is shown in FIG. 4, which is a sectional view for illustrating the composite railings according to embodiment 3, includes a carbon steel core 10 and a aluminium composite out-layer 20. In this embodiment, the material of the composite out-layer 20 is aluminium, without limitation, the other materials e.g. zinc, copper, zinc-aluminium alloy, magnesium-aluminium alloy are also suitable to the embodiment

The carbon steel core 10 is a hollow line stick, with regular rectangle on cross section, combined with the composite out-layer 20 by high pressure forging. The outer shape of the composite out-layer 20 is complex carving, so the products of railings form the complex carving structure. The shape of this embodiment is carving, without limitation, the other structures e.g. figures, animals are also makeable.

### Embodiment 4

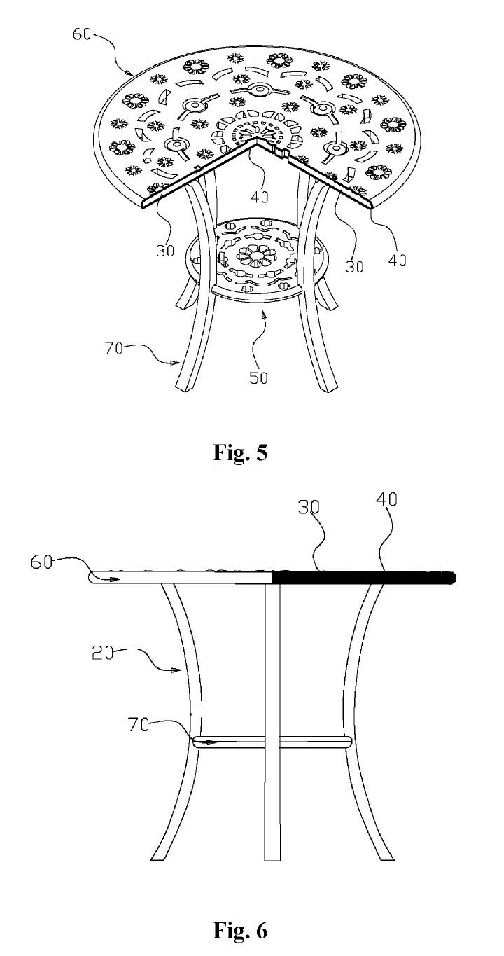

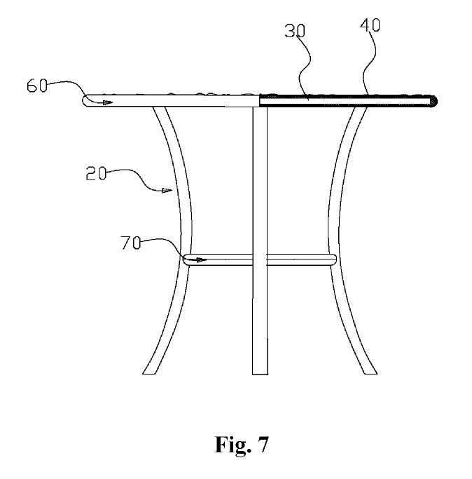

A composite metal gardening table, as shown in FIG. 5 and FIG. 6, FIG. 5 is a perspective view and FIG. 6 is a sectional view, both of them illustrating the gardening table according to embodiment 4 of the invention, includes the board unit 60, leg unit 70 and rack unit 50.

Each of the board unit 60, leg unit 70 and rack unit 50 is composite unit in this embodiment, without limitation, the other combinations are also suitable to the embodiment, e.g. composite board unit 60 with not-composite leg unit 70, or composite leg unit 70 with not-composite board unit 60.

The composite unit includes a carbon steel core 30 and a composite aluminium out-layer 40, the composite out-lay 40 combined with the carbon steel core 30 by high pressure forging, which makes that there aren't any surface of the carbon steel core directly contact with the air. In this embodiment, the material of the composite out-layer 40 is aluminium, without limitation, the other materials, e.g. zinc, copper, zinc-aluminium alloy, magnesium-aluminum alloy are also suitable to the embodiment

The carbon steel core 30 is solid, with complex shape which matches the shape of board unit 60 or leg unit 70. The core 30 combined with the composite our-layer 40 by high pressure forging, the thickness of the composite our-layer 40 is uniformly 2 mm, thus the whole shape of the composite unit present the needed shape of board unit 60 or leg unit 70, e.g. carvings. In this embodiment, the shape is carving structure, without limitation, the other structures e.g. figures, animals etc. are also makable. There are ventholes in the carving structure of board unit 60 as shown in FIG. 5.

Detailed description of the manufacture process of the composite unit:

P100, step of the manufacture process of core 30, in which the needed complex shape of carbon steel core 30, e.g. carving, figures, animals, etc. are produced by hot rolling or cold rolling.

P200, step of beginning, in which the needed working mould are put on the working machine, the mould is special steel mould and its inside cavity has the needed shape of railings.

P300, step of setting, in which the carbon steel core 30 are put into the working mould.

P400, step of high pressure forging, in which the melted aluminium liquid is inpoured to the working mould on high pressure, which will fuse to the carbon steel core

P500, step of opening, in which the products are take out from the mould, being the railings with needed shape. There can also take some simple process, e.g. spraying to them or grinding to the corners and flanges when need

After the board unit and leg unit are produced by the above-mentioned method, the board unit and the leg unit are assembled with each other by weld or bolt-joining. The joining part are directly manufactured on board unit, leg unit and rack unit.

### Embodiment 5

The difference in this embodiment to embodiment 4 is that: a composite metal gardening table, the composite unit includes a carbon steel core 30 and a composite aluminium out-layer 40, the carbon steel core 30 is a solid regular stick, combined with the composite our-layer 40 by high pressure forging, the thickness of the composite our-layer 40 is nonuniform, thus the shape of the unit present to the needed complex structure of board unit 60 or leg unit 70, e.g. carving.

### Embodiment 6

The difference in this embodiment to embodiment 4 is that: a composite metal gardening table, as shown in FIG. 7, which is a sectional view for illustrating the gardening chair according to the embodiment 6. The composite unit includes a carbon steel core 30 and a composite aluminium out-layer 40. The carbon steel core 30 is hollow, with complex shape which matches the out-shape of board unit or leg unit 70.

### Embodiment 7

A composite metal gardening chair includes board unit, leg unit and back unit.

Each of the board unit, leg unit and back unit is composite unit in this embodiment, without limitation, the other combinations are also suitable to the embodiment, e.g. composite board unit with not-composite leg unit, or composite leg unit with not-composite board unit.

The composite unit includes a carbon steel core and a composite aluminium out-layer, the composite out-lay combined with the carbon steel core 30 by high pressure forging, which makes that there aren't any surface of the carbon steel core directly contact with the air. In this embodiment, the material of the composite out-layer is aluminium, without limitation, the other materials e.g. zinc, copper, zinc-aluminium alloy, magnesium-aluminum alloy are also suitable to the embodiment

The carbon steel core is solid, with complex structure which matches the shape of board unit or leg unit. The core combined with the composite our-layer by high pressure forging, the thickness of the composite our-layer 40 is uniformly 2 mm, thus the whole shape of the composite unit present the needed shape of board unit or leg unit, e.g. carving. In this embodiment the shape is carving structure, without limitation, the other structures, e.g. figures, animals etc. are also makable. There are ventholes in the carving structure of board unit

Detailed description of the manufacture process of the composite unit:

P100, step of the manufacture process of core, in which the needed complex shape of carbon steel core, e.g. carving, figures, animals, etc. are produced by hot rolling or cold rolling.

P200, step of beginning, in which the needed working mould are put on the working machine, the mould is special steel mould and its inside cavity has the needed shape of railings.

P300, step of setting, in which the carbon steel core are put into the working mould.

P400, step of high pressure forging, in which the melted aluminum liquid is inpoured to the working mould on high pressure, which will fuse to the carbon steel core.

P500, step of opening, in which the product are take out from the mould, being the railings with needed shape there also can take some simple process e.g. spraying to them or grinding to the corners and flanges when need

After the board unit and leg unit are produced by the above method, the board unit and the leg unit are assembled with each other by weld or bolt-joining. The joining part are directly manufactured on board unit, leg unit and rack unit.

Utility in Industry

The present invention provides composite metal articles and production method therefore, wherein the carbon steel core combined with a composite stainless metal or alloy out-layer, which makes a quick processing speed, high production efficiency and low cost in manufacture, and it can widely used in industry field.

What claimed is:

1. A composite metal article characterized in that it includes a carbon steel core and a dissimilar composite metal out-layer, said out-layer combined with the carbon steel core by high pressure forging.

2. The composite metal article according to claim 1, wherein the composite out-layer is copper composite out-layer, aluminium composite out-layer or zinc composite out-layer.

3. The composite metal article according to claim 1, wherein the composite out-layer is zinc-aluminium alloy out-layer or magnesium-aluminium alloy composite out-layer.

4. The composite metal article according to claim 1, wherein the thickness of composite out-layer is 1.0-5.0 mm.

5. The composite metal article according to claim 1, wherein the carbon steel core is hollow carbon steel core or solid carbon steel core.

6. The composite metal article according to claim 1, wherein there are carvings on the composite metal article.

7. A composite metal railing characterized in that it includes a carbon steel core and a dissimilar metal composite out-layer, said out-layer combined with the carbon steel core by high pressure forging.

8. The composite metal railing according to claim 7, wherein the composite out-layer is copper composite out-layer, aluminium composite out-layer or zinc composite out-layer.

9. The composite metal railing according to claim 7, wherein the composite out-layer are zinc-aluminium alloy out-layer or magnesium-aluminium alloy composite out-layer.

10. The composite metal railing according to claim 7, wherein the thickness of composite out-layer is 1.0-5.0 mm.

11. The composite metal railing according to claim 7, wherein the carbon steel core is hollow carbon steel core or solid carbon steel core.

12. The composite metal railing according to claim 7, wherein there are carvings on the composite metal article.

13. A composite metal table/chair, includes a board unit and a leg unit, wherein, at least one unit is composite unit, the composite unit includes a carbon steel core and a dissimilar composite metal out-layer which combined with the carbon steel core by high pressure forging.

14. A composite metal table/chair according to claim 13, wherein both of the board unit and the leg unit are composite units.

15. A composite metal table/chair according to claim 13, wherein the board unit is composite unit.

16. A composite metal table/chair according to claim 13, wherein the leg unit is composite unit.

17. A composite metal table/chair according to claim 13, wherein the composite out layer is copper composite out-layer, aluminium composite out-layer, zinc composite out-layer or zinc-aluminium alloy composite out-layer or magnesium-aluminium alloy composite out-layer.

18. A composite metal table/chair according to claim 13, wherein the thickness of composite out-layer is 1.0-5.0 mm.

19. A composite metal table/chair according to claim 13, wherein the carbon steel core is hollow carbon steel core or solid carbon steel core.

20. A composite metal table/chair according to claim 13, wherein there are carvings on the board unit, or on the leg unit, or there are carvings on both of the board unit and leg unit.
